(19) United States
(12) Patent Application Publication
(10) Pub. No.: US 2024/0046192 A1
(43) Pub. Date: Feb. 8, 2024

(54) MANAGEMENT DEVICE, MANAGEMENT METHOD, AND MANAGEMENT SYSTEM

(71) Applicant: TOYOTA JIDOSHA KABUSHIKI KAISHA, Toyota-shi (JP)

(72) Inventors: Atsushi KOMADA, Nagakute-shi (JP); Mitsuru OGASAWARA, Gamagori-shi (JP); Masahiko ISHII, Okazaki-shi (JP); Hidetaka ASANO, Nissin-shi (JP); Tomokazu ISHII, Okazaki-shi (JP); Koji HETSUGI, Toyota-shi (JP); Kosuke YONEKAWA, Nissin-shi (JP); Yoshikazu JIKUHARA, Miyoshi-shi (JP)

(73) Assignee: TOYOTA JIDOSHA KABUSHIKI KAISHA, Toyota-shi (JP)

(21) Appl. No.: 18/355,183

(22) Filed: Jul. 19, 2023

(30) Foreign Application Priority Data
Aug. 4, 2022 (JP) 2022-124890

(51) Int. Cl. G06Q 10/0639; G06Q 10/0637

(52) U.S. Cl. CPC G06Q 10/06395; G06Q 10/06375

(57) ABSTRACT

A management device of a second corporation being configured to manage at least one product delivered from a first corporation on an upstream side to the second corporation on a downstream side, includes a first controller that is configured to transmit identification information of the product to the first corporation, and a second controller that is configured to manage the product. A first management device of the first corporation is configured to transmit, based on receiving the identification information from the first controller, first information to the first controller. The first information is information based on a first carbon dioxide amount emitted due to manufacturing the product. The second controller is configured to manage the product and the first carbon dioxide amount in correlation with each other.

### CROSS-REFERENCE TO RELATED APPLICATION

This application claims priority to Japanese Patent Application No. 2022-124890 filed on Aug. 4, 2022, incorporated herein by reference in its entirety.

### BACKGROUND

### 1. Technical Field

The present disclosure relates to a management device, management method, and management system.

### 2. Description of Related Art

A growing awareness of environmental issues is leading to increased interest in emission amounts of carbon dioxide emitted in order to manufacture products that are distributed on the market. Upstream corporations in a supply chain may be requested by downstream corporations, to which they deliver products, to disclose emission amounts of carbon dioxide emitted to manufacture the products. The upstream corporations calculate the emission amounts of carbon dioxide emitted to manufacture the products, and perform disclosure thereof to the downstream corporations. For example, Japanese Unexamined Patent Application Publication No. 2016-126372 (JP 2016-126372 A) discloses a technique of calculating emission amounts of carbon dioxide in a transportation process of products (including materials and parts). Upon acquiring the information indicating the emission amounts of carbon dioxide from the upstream corporations, the downstream corporations manage the information indicating the emission amounts of carbon dioxide in association with the corresponding products that are delivered thereto.

### SUMMARY

Now, in JP 2016-126372 A, a downstream corporation may acquire information indicating emission amounts of carbon dioxide from an upstream corporation at an unintended and inappropriate timing. In this case, there is a possibility that managing emission amounts of carbon dioxide will become difficult, and management errors may occur. Accordingly, it is desirable to suppress occurrence of management errors regarding emission amounts of carbon dioxide related to products.

The present disclosure provides a management device, a management method, and a management system, capable of suppressing management errors regarding emission amounts of carbon dioxide related to products from occurring.

A first aspect of the present disclosure is a management device of a second corporation being configured to manage at least one product delivered from a first corporation on an upstream side to the second corporation on a downstream side. The management device includes a first controller that is configured to transmit identification information of the product to the first corporation, and a second controller that is configured to manage the product. A first management device of the first corporation is configured to transmit, based on receiving the identification information from the first controller, first information to the first controller. The first information is information based on a first carbon dioxide amount emitted due to manufacturing the product. The second controller is configured to manage the product and the first carbon dioxide amount, in correlation with each other based on the first information acquired by the first controller.

In the first aspect, the first controller may be configured to receive second information based on a second carbon dioxide amount emitted due to manufacturing and transporting the product.

In the first aspect, the second controller may be configured to, when a plurality of the products are delivered to the second corporation, manage a carbon dioxide emission amount per product, and the product, in correlation with each other. According to this configuration, the emission amount of carbon dioxide per product can be managed, regardless of the count of delivered products.

In the first aspect, the management device may further include a third controller that acquires the identification information, based on code information attached to the product. As a result, transmission of incorrect identification information to the first corporation can be suppressed.

In the first aspect, the first corporation may receive, from a third corporation on an upstream side of the first corporation, delivery of a constituent product from which the product is made. The first controller may be configured to receive third information based on the first carbon dioxide amount at the first corporation and a third carbon dioxide amount, the third carbon dioxide amount being emitted due to the manufacturing of the constituent product at the third corporation. The second controller may be configured to manage a total value of the first carbon dioxide amount and the third carbon dioxide amount, and the product, in correlation with each other.

A second aspect of the present disclosure is a management method for managing a product at a second corporation, the product being delivered from a first corporation on an upstream side to the second corporation on a downstream side. The management method includes transmitting identification information of the product from the second corporation to the first corporation, transmitting, based on the identification information being received by a first management device of the first corporation, first information from the first corporation to the second corporation, and managing, at the second corporation, the product, and the first carbon dioxide amount, in correlation with each other based on the first information. The first information is information based on a first carbon dioxide amount emitted due to manufacturing of the product.

A third aspect of the present disclosure is a management system. The management system includes a first management device provided in a first corporation on an upstream side, and a management device provided in a second corporation on a downstream side, a product being delivered from the first corporation to the second corporation. The management device is configured to transmit identification information of the product to the first corporation. The management device is configured to manage the product. The first management device is configured to transmit, based on the first management device receiving the identification information, first information to the management device. The first information is information based on a first carbon dioxide amount emitted due to manufacturing the product. The management device is configured to manage the product, and the first carbon dioxide amount, in correlation with each other based on the first information.

According to the first aspect, the second aspect, and the third aspect of the present disclosure, management errors regarding emission amounts of carbon dioxide related to products can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a management system according to an embodiment;

FIG. 2 is a diagram illustrating a packing box in which products are packed, according to the embodiment;

FIG. 3 is a sequence diagram of the management system according to the embodiment; and

FIG. 4 is a diagram showing a management table managed by a management unit according to the embodiment.

### DETAILED DESCRIPTION OF EMBODIMENTS

An embodiment of the present disclosure will be described below in detail with reference to the drawings. In the drawings, the same or corresponding parts are denoted by the same reference signs and the description thereof will not be repeated.

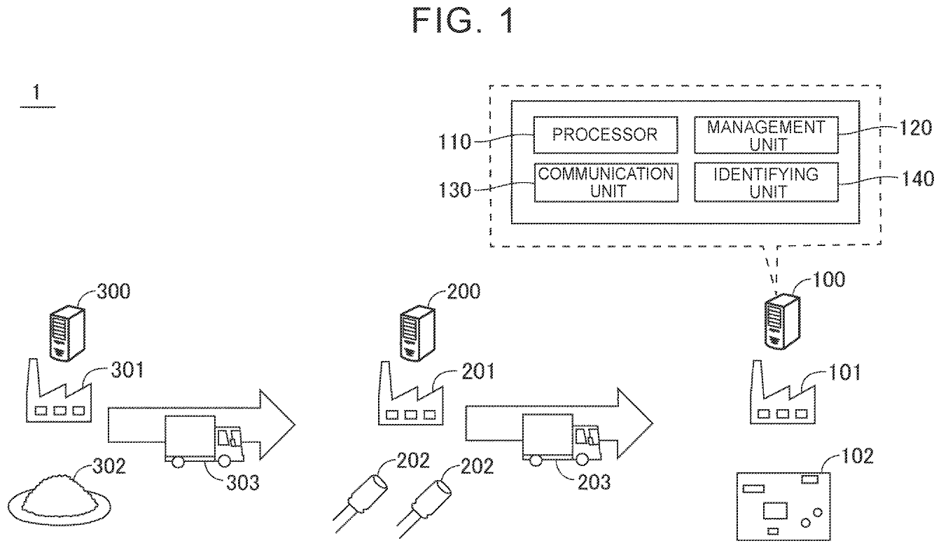

FIG. 1 is a diagram illustrating a configuration of a management system 1 according to the present embodiment. The management system 1 includes a management device 100 installed at a corporation 101, a management device 200 installed at a corporation 201, and a management device 300 installed at a corporation 301. Note that the corporation 101 and the corporation 201 are examples of a “second corporation” and a “first corporation” in the present disclosure, respectively. The corporation 301 is an example of a “third corporation” in the present disclosure. The management device 100 is an example of a “management device” and a “second management device” in the present disclosure. The management device 200 is an example of a “first management device” in the present disclosure.

The corporation 101 is situated on a downstream side from the corporation 201. Specifically, the corporation 101 receives delivery of a product 202 from the corporation 201. Also, the corporation 201 is situated on a downstream side from the corporation 301. Specifically, the corporation 201 receives, from the corporation 301, a product 302 from which the product 202 is made. It should be noted that the product from which the product 202 is made also includes parts that make up the product 202 by being combined with other parts. Also, a new product 102 manufactured by the corporation 101 using the product 202 may be delivered to corporations on a downstream side of the corporation 101. Also, the management device 100 manages the product 202. Note that the product 302 is an example of a “constituent product” in the present disclosure.

Also, the product 202 is transported to the corporation 101 by a transport vehicle 203 after being manufactured at the corporation 201. Also, the product 302 is transported to the corporation 201 by a transport vehicle 303 after being manufactured at the corporation 301.

The management device 100 includes a processor 110, a management unit 120, a communication unit 130, and an identifying unit 140. The processor 110 controls each of the management unit 120, the communication unit 130, and the identifying unit 140.

The communication unit 130 communicates with an unshown communication unit of the management device 200. The communication unit 130 includes various types of communication interfaces. Note that the unshown communication unit of the management device 200 communicates with an unshown communication unit of the management device 300. Note that the communication unit 130 is an example of a first controller in the present disclosure.

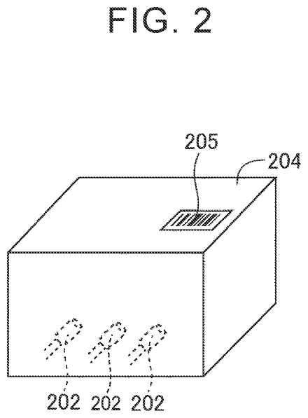

Now, a packing box 204 (see FIG. 2) packed with a plurality of the product 202 is transported from the corporation 201 to the corporation 101. A barcode 205 (see FIG. 2) is attached to the packing box 204. Note that the barcode 205 is an example of “code information” in the present disclosure.

The identifying unit 140 of the management device 100 can read (scan) the barcode 205. That is to say, the identifying unit 140 includes a barcode reader. The identifying unit 140 acquires identification information of the product 202 by reading the barcode 205. Note that the identifying unit 140 is an example of a third controller.

The identification information of the products 202 includes a delivery number, delivery date and time, information regarding the delivering corporation (in this case, the corporation 201), information regarding the count of products 202 in the packing box 204, and so forth. Each piece of the above information is managed (stored) in the management unit 120. Note that the management unit 120 is an example of a second controller.

Product Management Method

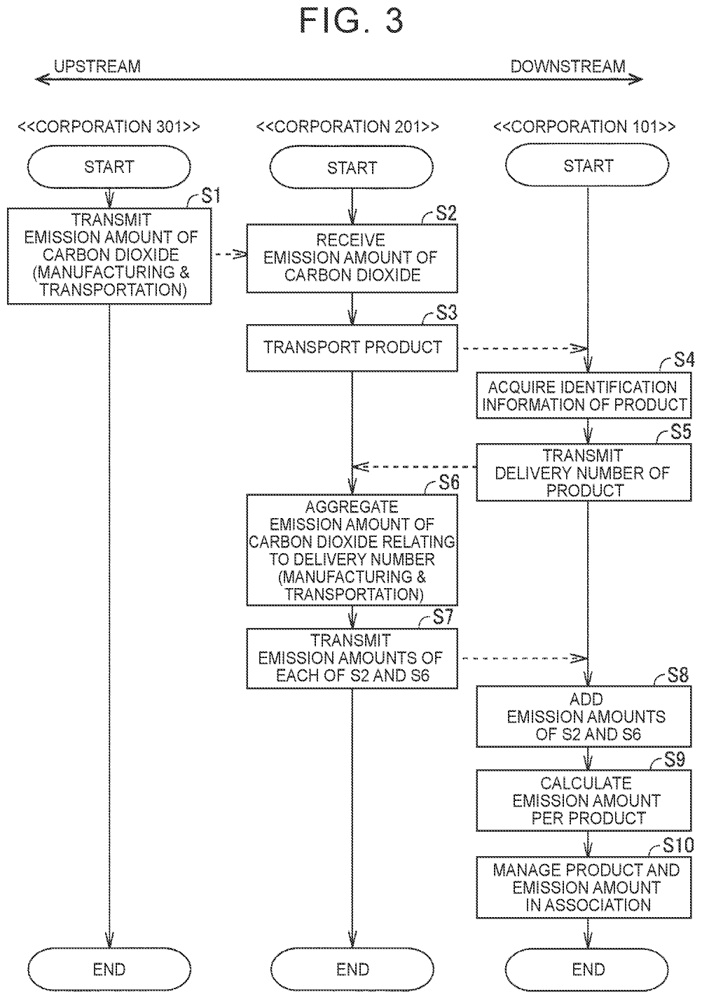

Next, a management method for managing the product 202 will be described with reference to a sequence diagram in FIG. 3. A management method for managing emission amounts of carbon dioxide related to the product 202 will be described.

First, in step S1, the corporation 301 (management device 300) transmits, to the corporation 201, information regarding the emission amount of carbon dioxide emitted due to the production of the product 302 on a manufacturing line of the corporation 301. Also, the corporation 301 (management device 300) transmits, to the corporation 201, information regarding the amount of carbon dioxide emitted from the transport vehicle 303 when the product 302 is transported by the transport vehicle 303. Note that the corporation 301 (management device 300) may transmit, to the corporation 201, a total value of the amount of carbon dioxide emitted during the manufacturing of the product 302, and the amount of carbon dioxide emitted during transportation of the product 302. Also, the amount of carbon dioxide emitted during transportation of the product 302 may be transmitted to the corporation 201 from a corporation that manages the transport vehicle 303. Note that the emission amount of carbon dioxide emitted due to the manufacturing of the product 302 on the manufacturing line of the corporation 301 is an example of a third carbon dioxide amount. Also, information regarding the emission amount of carbon dioxide emitted due to the manufacturing of the product 302 on the manufacturing line of the corporation 301 and the amount of carbon dioxide emitted due to the manufacturing of the product 202 is an example of third information.

Next, in step S2, the corporation 201 (management device 200) receives the information of the emission amount of carbon dioxide, transmitted in step S1. Note that when there is a corporation further upstream from the corporation 301, the corporation 201 (management device 200) may also receive information regarding the amount of carbon dioxide emitted by the upstream corporation, and the amount of carbon dioxide emitted during transportation of the product from the upstream corporation to the corporation 301.

Next, in step S3, the corporation 201 transports the products 202 to the corporation 101 using the transport vehicle 203. The products 202 are packed in the packing box 204 (see FIG. 2) and transported. Note that in the present embodiment, assumption will be made that only the packing box 204 is being transported by the transport vehicle 203.

Next, in step S4, the management device 100 (identifying unit 140) of the corporation 101 reads (scans) the barcode 205 attached to the packing box 204 transported in step S3. Thus, the management device 100 acquires the identification information of the products 202.

Next, in step S5, the management device 100 (processor 110) transmits the delivery number included in the identification information acquired in step S4 to the corporation 201 (management device 200) through the communication unit 130.

Next, in step S6, the corporation 201 (management device 200) aggregates (calculates) the emission amounts of carbon dioxide related to the products 202 that correspond to the delivery number transmitted in step S5. Specifically, the management device 200 calculates the amount of carbon dioxide emitted due to manufacturing the products 202, based on an electricity consumption amount of a manufacturing line of the product 202. The management device 200 also calculates the amount of carbon dioxide emitted due to the transportation of the products 202 based on a fuel consumption amount, and an emission factor of the fuel consumed by the transport vehicle 203. Note that the method for calculating the emission amount of carbon dioxide is not limited to the above example. Now, the amount of carbon dioxide emitted due to the manufacturing of the product 202 is an example of a first carbon dioxide amount. Also, a carbon dioxide amount obtained by aggregating the amount of carbon dioxide emitted due to manufacturing the product 202 and the amount of carbon dioxide emitted due to transportation of the product 202 is an example of a second carbon dioxide amount.

Next, in step S7, the corporation 201 (management device 200) transmits information regarding the amount of carbon dioxide emitted due to each of the manufacturing and the transportation of the product 202, aggregated (calculated) in step S6, to the management device 100 (communication unit 130) of the corporation 101. Also, the management device 200 transmits information regarding the amount of carbon dioxide emitted in each of the manufacturing and the transportation of the product 302, received in step S2, to the management device 100 (communication unit 130). Now, information regarding the amount of carbon dioxide emitted due to the manufacturing of the product 202 is an example of first information. Also, information regarding the amount of carbon dioxide emitted due to each of the manufacturing and the transportation of the product 202 is an example of second information. Note that at this time, the emission amount of carbon dioxide to be transmitted may be calculated as appropriate based on a ratio of a count of the products 202 transported, as to a count of the products 202 manufactured, or the like. Also, both the first information and the second information may be received separately.

Next, in step S8, the management device 100 (processor 110) of the corporation 101 adds the emission amount of carbon dioxide corresponding to step S2 (emission amount due to manufacturing and transporting the product 302) and the emission amount of carbon dioxide corresponding to step S6 (emission amount due to manufacturing and transporting the product 202). Thus, the total amount of carbon dioxide emitted for manufacturing the product 202 is calculated. Note that a value obtained by multiplying the emission amount of carbon dioxide corresponding to step S2 by a predetermined coefficient may be added to the emission amount of carbon dioxide corresponding to step S6. Note that the predetermined coefficient may vary depending on the count (quantity) of the product 302 used to manufacture the product 202.

Next, in step S9, the management device 100 calculates the emission amount of carbon dioxide per product 202. Specifically, the management device 100 (processor 110) divides the total value of emission amounts of carbon dioxide calculated in step S8 by the count of products 202 included in the identification information acquired in step S4.

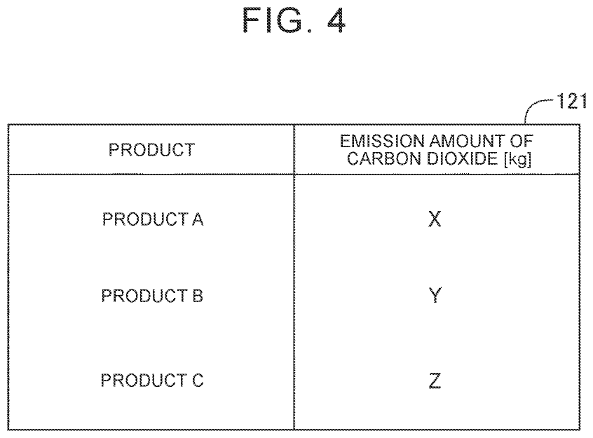

Then, in step S10, the management device 100 (management unit 120) manages the emission amount of carbon dioxide per product 202 calculated in step S9, and the product 202, in association (in correlation) with each other. For example, the management unit 120 may store a management table 121 (see FIG. 4) in which the products 202 and emission amounts of carbon dioxide thereof are associated. FIG. 4 shows an example in which emission amounts of carbon dioxide are associated with each product (each of A, B, and C). In FIG. 4, the products 202 are referred to as products A to C, in order to distinguish therebetween.

Also, the corporation 101 (management device 100) manages the emission amount of carbon dioxide for each part, with the emission amount of carbon dioxide in association with each of the delivered products (see FIG. 4). The emission amount of carbon dioxide for each part used in the product 102 manufactured by the corporation 101 is then added to the emission amount of carbon dioxide emitted during the manufacturing of the product 102, thereby calculating the emission amount of carbon dioxide emitted with relation to the product 102.

As described above, in the embodiment, the identification information of the product 202 is transmitted to the corporation 201 from the communication unit 130, whereby the carbon dioxide amount that is emitted due to manufacturing the product 202 is transmitted from the corporation 201 to the corporation 101. The management unit 120 manages the product 202 and the carbon dioxide amount in association with each other, based on the information of the carbon dioxide amount that is transmitted thereto. Thus, information regarding the carbon dioxide amount can be suppressed from being transmitted from the corporation 201 at an inappropriate timing for the corporation 101. As a result, the corporation 101 can manage the information regarding the emission amount of carbon dioxide for the product 202 that is delivered more readily in association with the product 202 that corresponds thereto. This facilitates management of the product 202. As a result, management errors regarding the emission amount of carbon dioxide with relation to the product 202 can be suppressed from occurring.

Although an example is described in the above embodiment in which the emission amount of carbon dioxide per product and the product are managed in association with each other, the present disclosure is not limited to this. For example, multiple products that are delivered, and the total amount of the emission amount of carbon dioxide corresponding to the multiple products, may be managed in association with each other. In this case, the emission amount of carbon dioxide may be managed in increments of packing boxes, or the emission amount of carbon dioxide may be managed in increments of transport vehicles.

Although an example is described in the above embodiment in which the barcode 205 is attached to the packing box 204, the present disclosure is not limited to this. For example, a barcode may be attached to each of the products 202. Also, code information different from this barcode (e.g., a two-dimensional barcode) may be used. The delivery number may be attached to the product 202, the packing box 204, or the like, and the delivery number may be transmitted to the corporation 201 based on an operator inputting the delivery number at the management device 100.

Although an example is described in the above embodiment in which the emission amount of carbon dioxide corresponding to the corporation 301 and the emission amount of carbon dioxide corresponding to the corporation 201 are added in the management device 100 of the corporation 101, the present disclosure is not limited to this. For example, the management device 200 of the corporation 201 may perform the adding processing. Also, the management device 200 may calculate the emission amount of carbon dioxide per product.

Although an example is described in the above embodiment in which the emission amount of carbon dioxide corresponding to the corporation 301 and the emission amount of carbon dioxide corresponding to the corporation 201 are added, the present disclosure is not limited to this. An arrangement may be made in which the emission amount of carbon dioxide corresponding to the corporation 301 is omitted from consideration.

Although an example is described in the above embodiment in which the corporation 201 calculates the emission amount of carbon dioxide, and transmits information regarding the emission amount to the corporation 101, the present disclosure is not limited to this. For example, the corporation 101 (management device 100) may acquire, from the corporation 201, information regarding the electric power consumption of the manufacturing line of the corporation 201, information regarding the fuel consumption of the transport vehicle 203, and so forth, and calculate the emission amount of carbon dioxide itself, based on the acquired information.

Although an example is described in the above embodiment in which the corporation 101 (management device 100) acquires, from the corporation 201, information regarding the amount of carbon dioxide emitted in the manufacturing and the transportation of the product 302, the present disclosure is limited to this. The corporation 101 (management device 100) may acquire information regarding the amount of carbon dioxide emitted in manufacturing and transportation of the product 302 from the corporation 301.

Note that when multiple types of products are transported at the same time, the amount of carbon dioxide emitted for transporting the products may be calculated based on the weight of the products. For example, the amount of carbon dioxide emitted in order to transport a single product may be calculated based on a ratio of the weight of each product as to the total weight of products loaded on a transport vehicle, and the total amount of carbon dioxide emitted during transportation.

Also, history of emission amounts of carbon dioxide corresponding to products may be managed among multiple corporations by blockchain.

The embodiment disclosed herein should be considered to be exemplary and not restrictive in all respects. The scope of the present disclosure is set forth by the claims rather than by the above description of the embodiments, and is intended to include all modifications within the meaning and scope equivalent to the claims.

What is claimed is:

1. A management device of a second corporation being configured to manage at least one product delivered from a first corporation on an upstream side to the second corporation on a downstream side, the management device comprising:
a first controller that is configured to transmit identification information of the product to the first corporation; and
a second controller that is configured to manage the product, wherein
a first management device of the first corporation is configured to transmit, based on receiving the identification information from the first controller, first information to the first controller,
the first information is information based on a first carbon dioxide amount emitted due to manufacturing the product, and
the second controller is configured to manage the product and the first carbon dioxide amount, in correlation with each other based on the first information acquired by the first controller.

2. The management device according to claim 1, wherein the first controller is configured to receive second information based on a second carbon dioxide amount emitted due to manufacturing and transporting the product.

3. The management device according to claim 1, wherein the second controller is configured to, when a plurality of the products are delivered to the second corporation, manage a carbon dioxide emission amount per product, and the product, in correlation with each other.

4. The management device according to claim 1, further comprising a third controller that acquires the identification information, based on code information attached to the product.

5. The management device according to claim 1, wherein:
the first corporation receives, from a third corporation on an upstream side of the first corporation, delivery of a constituent product from which the product is made;
the first controller is configured to receive third information based on the first carbon dioxide amount at the first corporation and a third carbon dioxide amount, the third carbon dioxide amount being emitted due to manufacturing of the constituent product at the third corporation; and
the second controller is configured to manage a total value of the first carbon dioxide amount and the third carbon dioxide amount, and the product, in correlation with each other.

6. A management method for managing a product at a second corporation, the product being delivered from a first corporation on an upstream side to the second corporation on a downstream side, the management method comprising:
transmitting identification information of the product from the second corporation to the first corporation;
transmitting, based on the identification information being received by a first management device of the first corporation, first information from the first corporation to the second corporation, the first information being information based on a first carbon dioxide amount emitted due to manufacturing of the product; and
managing, at the second corporation, the product and the first carbon dioxide amount, in correlation with each other based on the first information.

7. A management system, comprising:
a first management device provided in a first corporation on an upstream side; and
a management device provided in a second corporation on a downstream side, a product being delivered from the first corporation to the second corporation, wherein
the management device is configured to transmit identification information of the product to the first corporation,
the management device is configured to manage the product,
the first management device is configured to transmit, based on the first management device receiving the identification information, first information to the management device,
the first information is information based on a first carbon dioxide amount emitted due to manufacturing the product, and
the management device is configured to manage the product and the first carbon dioxide amount, in correlation with each other based on the first information.
